(19) United States
(12) Patent Application Publication
(10) Pub. No.: US 2025/0384798 A1
(43) Pub. Date: Dec. 18, 2025

(54) METHOD OF MEASURING LIGHT PROPERTY OF DISPLAY DEVICE AND METHOD OF DRIVING DISPLAY DEVICE BASED ON MEASUREMENT OF LIGHT PROPERTY

(71) Applicant: Samsung Display Co., LTD., Yongin-si (KR)

(72) Inventor: Ja Eun LEE, Yongin-si (KR)

(21) Appl. No.: 19/043,787

(22) Filed: Feb. 3, 2025

(30) Foreign Application Priority Data
Jun. 13, 2024 (KR) 10-2024-0077017

(51) Int. Cl. G09G 3/00

(52) U.S. Cl. CPC G09G 3/006; G09G 2320/0233; G09G 2320/0666; G09G 2360/145; G09G 2360/16

(57) ABSTRACT

A method of measuring light properties of a display device includes measuring the light properties of a measurement target region of a display device with a measuring device having a higher resolution than that of the display device, determining an appropriate window for a target region, repeatedly changing the position of the appropriate window within the target region, calculating the average value of light properties within the appropriate window for each position of the appropriate window, and averaging the average values of the light properties within the appropriate window and determining an average light characteristic value of the measurement target region.

This application claims priority to Korean Patent Application No. 10-2024-0077017, filed on Jun. 13, 2024, and all the benefits accruing therefrom under 35 U.S.C. § 119, the content of which in its entirety is herein incorporated by reference.

### BACKGROUND

### 1. Technical Field

The disclosure relates to a method of measuring light properties of a display device and a method of driving the display device based on the measurement of these light properties.

### 2. Description of the Related Art

A display device is a device that provides visual information such as images to users and is used in various electronic devices such as computers, TVs, game devices, and smartphones.

Smartphones are generally equipped with a camera, and in order to increase the screen size, under display camera (“UDC”) or under panel camera (“UPC”) technology is used, which uses the region where the camera is placed as a screen. In this technology, the pixel arrangement or wiring structure of the region where the camera is placed—that is, the camera region—may be different from remaining regions. In this case, the camera region may have different light properties than remaining regions, such as luminance and chromaticity. In other words, the camera region and remaining regions may display different luminance and chromaticity for the same display signal. Therefore, the display signal supplied to the camera region may be properly corrected so that the intended image may be displayed properly.

### SUMMARY

One problem that the disclosure aims to solve is to more accurately measure the light properties of a display device. Another problem that the disclosure aims to solve is to more accurately measure the light properties of a region of a display device with a heterogeneous structure and more accurately display the intended image in the region.

A method of measuring light properties of a display device in an embodiment of the disclosure includes measuring the light properties of a measurement target region of a display device with a measuring device having a higher resolution than that of the display device, determining an appropriate window for a target region, repeatedly changing the position of the appropriate window within the target region, calculating the average value of light properties within the appropriate window for each position of the appropriate window, and averaging the average values of the light properties within the appropriate window and determining an average light characteristic value of the measurement target region.

In an embodiment of the disclosure, the proper window may be rectangular.

In an embodiment of the disclosure, the measurement target region of the display device has a structure in which repeating units are repeated, and a size of the appropriate window may be a multiple of a size corresponding to the repeating unit in the target region.

In an embodiment of the disclosure, the determining the appropriate window includes, setting a plurality of temporary windows of different sizes for the target region, repeatedly changing a position of each of the plurality of temporary windows within the target region, calculating an average value of an in-window light characteristic for each position of each of the plurality of temporary windows, comparing the average value of the in-window light characteristic for each of the plurality of temporary windows, and, as a result of the comparing the average value of the in-window light characteristic, determining that a standard deviation of the average value of the in-window light characteristic is minimal among the plurality of temporary windows, calculating, for each of the plurality of temporary windows, a standard deviation of the in-window light characteristic mean value, comparing the standard deviations, and determining, as a result of the comparing the standard deviations, the temporary window having the least standard deviation among the plurality of temporary windows as the appropriate window.

In an embodiment of the disclosure, the setting the plurality of temporary windows of the different sizes may include setting an initial window of the plurality of temporary windows, and then setting other temporary windows by reducing a size of the initial window in turn.

In an embodiment of the disclosure, the setting the initial window setting step may include setting the size of the initial window to about ⅓ to about ½ of the target region.

In an embodiment of the disclosure, the setting the initial window may include setting the initial window to a square shape.

In an embodiment of the disclosure, the setting the different temporary windows may include setting a plurality of first temporary windows by decreasing the size of the initial window in a first direction in turn, and setting a plurality of second temporary windows by decreasing the size of the initial window in a second direction perpendicular to the first direction in turn.

In an embodiment of the disclosure, the determining the appropriate window includes setting an initial window for the target region, setting a plurality of first temporary windows including the initial window by decreasing a size of the initial window in turn in a first direction, and iteratively changing a position of each of the plurality of first temporary windows within the target region, calculating, for each position of each of the plurality of first temporary windows, an average value of an in-window light characteristic, calculating, for each of the plurality of first temporary windows, a standard deviation of the average value of an in-window light characteristic, comparing the standard deviations of the plurality of first temporary windows, and, as a result of the comparing the standard deviations of the plurality of first temporary windows, determining, among the plurality of first temporary windows, a first temporary window having a minimum standard deviation as a provisional window, establishing a plurality of second temporary windows including the provisional window by reducing size of the provisional window in turn in a second direction perpendicular to the first direction, repeatedly changing the position of each of the plurality of second temporary windows within the target region, and calculating an average value of the in-window light properties for each position of each of the plurality of second temporary windows, calculating, for each of the plurality of second temporary windows, a standard deviation of the mean value of the in-window light properties, comparing the standard deviations of the plurality of second temporary windows, and, as a result of the comparing the standard deviations of the plurality of second temporary windows, determining, among the plurality of second temporary windows, a second temporary window having a minimum standard deviation as the appropriate window.

In an embodiment of the disclosure, the setting the initial window may include setting the size of the initial window to about ⅓ to about ½ of the target region.

In an embodiment of the disclosure, the setting the initial window may include setting the initial window to a square shape.

In an embodiment of the disclosure, the measurement target region of the display device displays an image together with the remaining region of the display device, and the measurement target region of the display device has a different pixel arrangement or a different wiring structure than the remaining region.

In an embodiment of the disclosure, the light characteristic may include at least one of luminance and chromaticity.

A method of operating an indicating device in an embodiment of the disclosure includes determining an average value of an light characteristic of a first region of an indicating device including a first region and a second region narrower than the first region, measuring the light characteristic of the second region with a light characteristic having a higher resolution than the indicating device; and determining an appropriate window for a target region of the light characteristic corresponding to the second region, repeatedly changing the position of the appropriate window within the target region, calculating, for each position of the appropriate window, an average value of the light properties within the appropriate window, averaging the average value of the light properties within the appropriate window to determine an average value of the light properties of the second region, and calibrating an indication signal supplied to the second region based on the difference between the average value of the light properties of the first region and the average value of the light properties of the second region.

In an embodiment of the disclosure, the first region and the second region display an image together, and the second region may have a different pixel arrangement or a different wiring structure than the first region.

In an embodiment of the disclosure, the appropriate window may be rectangular.

In an embodiment of the disclosure, the determining the appropriate window includes setting a plurality of temporary windows of different sizes for the target region, repeatedly changing a position of each of the plurality of temporary windows within the target region; calculating an average value of an in-window light characteristic for each position of each of the plurality of temporary windows, comparing the average value of the in-window light characteristic for each of the plurality of temporary windows, and, as a result of the comparison, determining that a standard deviation of the average value of the in-window light characteristic is minimal among the plurality of temporary windows, calculating, for each of the plurality of temporary windows, a standard deviation of the in-window light characteristic mean value, comparing the standard deviations, and determining, as a result of the comparing the standard deviations, the temporary window having the least standard deviation among the plurality of temporary windows as the appropriate window.

In an embodiment of the disclosure, the determining the appropriate window includes setting an initial window for the target region, setting a plurality of first temporary windows including the initial window by decreasing the size of the initial window in turn in a first direction, and iteratively changing a position of each of the plurality of first temporary windows within the target region, calculating, for each position of each of the plurality of first temporary windows, an average value of an in-window light characteristic, calculating, for each of the plurality of first temporary windows, a standard deviation of the average value of an in-window light characteristic, comparing the standard deviations of the plurality of first temporary windows, and, as a result of the comparing the standard deviations of the plurality of first temporary windows, determining, among the plurality of first temporary windows, a first temporary window having a minimum standard deviation as a provisional window, establishing a plurality of second temporary windows including the provisional window by reducing the size of the provisional window in turn in a second direction perpendicular to the first direction, repeatedly changing the position of each of the plurality of second temporary windows within the target region, and calculating an average value of the in-window light properties for each position of each of the plurality of second temporary windows, calculating, for each of the plurality of second temporary windows, a standard deviation of the mean value of the in-window light properties, comparing the standard deviations of the plurality of second temporary windows, and, as a result of the comparing the standard deviations of the plurality of second temporary windows, determining, among the plurality of second temporary windows, a second temporary window having a minimum standard deviation as the appropriate window.

In an embodiment of the disclosure, the setting the initial window may include setting the size of the initial window to about ⅓ to about ½ of the target region.

In an embodiment of the disclosure, the setting the initial window may include setting the initial window to a square shape.

By doing this, the light properties of the display device may be measured more accurately.

### BRIEF DESCRIPTION OF THE DRAWINGS

The above and other embodiments, advantages and features of this disclosure will become more apparent by describing in further detail embodiments thereof with reference to the accompanying drawings, in which:

FIG. 1 is a schematic diagram illustrating an embodiment of a method of measuring the light properties of a display device according to the disclosure.

FIGS. 2 to 4 are diagrams illustrating embodiments of windows according to various embodiments of the disclosure.

FIG. 5 is a flowchart illustrating an embodiment of a method of the measuring light properties of a display device according to the disclosure.

FIG. 6 to FIG. 8 are schematic diagrams for explaining an embodiment of a method of measuring the light properties of a display device according to the disclosure.

### DETAILED DESCRIPTION

Methods for measuring light properties of a display device according to various embodiments of the disclosure will be described in detail with reference to the attached drawings so that those skilled in the art may easily perform the method. The disclosure may be implemented in various different embodiments and is not limited to the embodiments described herein.

In order to clearly express various members and parts in the drawing, the size is enlarged or reduced. When a part (or member) is said to be “on” another part (or member), this includes not only cases where it is “directly above” the other part (or member), but also cases where there is another part (or member) in between. Conversely, when a part (or member) is said to be “right on top” of another part (or member), it means that there is no other part (or member) in between.

In this specification, terms such as “first” and “second” are used as modifiers for subsequent nouns, but unless clearly defined, they are only based on the order of description and do not have any type of (e.g., defined spatial, temporal, or logical) arrangement. Additionally, parts or members having the same or similar function in two or more drawings may be indicated by the same reference numerals. However, this is only for the purpose of simplifying illustration and explanation, and does not mean that parts or members indicated by the same reference numerals are structurally and functionally completely identical in all embodiments.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term “about” can mean within one or more standard deviations, or within +30%, 20%, 10%, 5% of the stated value, for example.

Unless otherwise stated, all terms (including technical and scientific terms) used herein have the same meaning as would be commonly known by a person of ordinary skill in the technical field to which the disclosure pertains. Unless otherwise defined, commonly used terms herein should be interpreted with the meaning used in the relevant technical field or with the meaning given in the dictionary, and should not be interpreted in an overly narrow or formal sense.

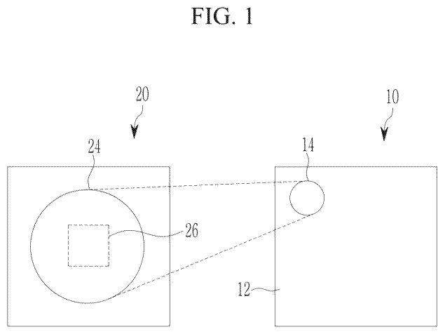

First, a method for measuring light properties of a display device in an embodiment of the disclosure will be described in detail with reference to FIG. 1.

FIG. 1 is a schematic diagram illustrating an embodiment of a method of measuring light properties of a display device according to the disclosure.

Referring to FIG. 1, first, the light properties are measured using a measuring device 20 capable of two-dimensional measurement, such as a camera, over the entirety of the region of the display device 10 or a part of the display device 10 that includes the measurement target region 14.

In the display device 10, the pixels of the measurement target region 14 may form the screen of the display device together with the pixels of the remaining region 12, but they may have a different structure from the pixels of the remaining region 12, such as a different pixel arrangement or a different wiring structure. The measurement target region 14 may be a camera region where a camera is placed, as in the case of a smartphone, for example.

The measuring device 20 may have a higher resolution than the display device 10, and accordingly, multiple pixels of the measuring device 20 may correspond to one pixel of the display device 10. In embodiments, light properties to be measured include luminance and chromaticity. Here, luminance is first explained as an example.

Next, a window 26, which is a reference region for measurement, is set within a target region 24 of the measuring device 20 corresponding to the measurement target region 14 of the display device 10. In an embodiment of the disclosure, the window 26 may be quadrangular, e.g., rectangular (e.g., a square).

By changing the position of the window 26 within the target region 24 and calculating the average luminance in each window 26, then summing up the average luminance obtained for each window 26 and dividing by the number of windows 26 to average them, the average luminance of the target region 24—that is, the average luminance of the measurement target region 14—is determined.

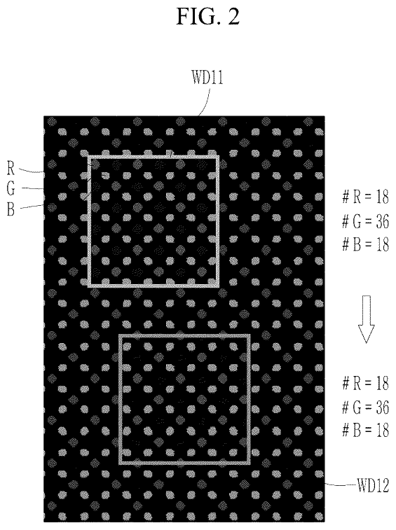

Next, a method for determining a window in an embodiment of the disclosure will be described in detail with reference to FIGS. 2 to 4.

FIGS. 2 to 4 are diagrams illustrating embodiments of windows according to various embodiments of the disclosure.

As previously mentioned, according to the disclosure, the shape of the window 26 may be quadrangular, e.g., rectangular (e.g., a square). When the shape of the window 26 is circular rather than square, there may be many cases where the border of the window 26 passes through the middle of a pixel (hereinafter referred to as a “display pixel”) of the display device 10. When the position of the window 26 is changed, the positional relationship between the border of the window 26 and the display pixel changes, so the error in the measured luminance between the windows 26 may increase. In particular, as the size of the measurement target region 14 or the size of the window 26 decreases, this error may become increaser.

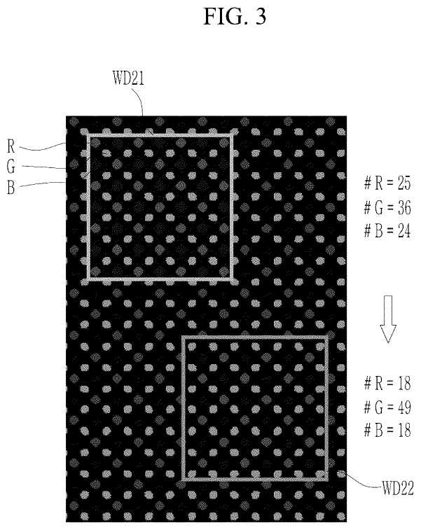

In an embodiment of the disclosure, the size of the window 26 may be set to a size that is a multiple of the minimum repeating unit of the pixel array of the display device 10. In an embodiment, in the case of the diamond pentile arrangement illustrated in FIGS. 2 and 3, a red subpixel and a green subpixel form one pixel—namely, a red-green pixel—and a blue subpixel and a green subpixel form one pixel—namely, a blue-green pixel—with red-green pixels and blue-green pixels arranged alternately, for example.

Therefore, two pixels next (adjacent) to each other—that is, a red-green pixel and a blue-green pixel next (adjacent) to each other—form a minimum repeating unit. Therefore, when the window 26 is set to a size equal to a multiple of the minimum repeating unit, the number of each subpixel remains unchanged even when the position of the window 26 changes.

The window 26 illustrated in FIG. 2 may include 18 repeating units. In this case, the number of subpixels does not change no matter where the window WD is disposed. In an embodiment, the upper window WD11 and the lower window WD12 each include 18 red subpixels, 18 blue subpixels, and 36 green subpixels, for example.

The size of the window 26 illustrated in FIG. 3 does not include a multiple of the minimum repeating unit.

In this case, the number of each subpixel may vary depending on the position of the window 26. In an embodiment, an upper window WD21 and a lower window WD22 are the same size, but the upper window WD21 includes 25 red pixels, 24 blue pixels, and 36 green pixels, while the lower window WD22 includes 18 red pixels, 18 blue pixels, and 49 green pixels, for example. In this way, when the number of each subpixel within the window 26 changes, the deviation of the average luminance within the window 26 may also increase.

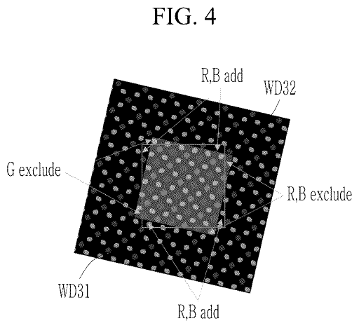

Measurement may be performed with the measuring device 20 not aligned with the display device 10 but at an angle. As illustrated in FIG. 4, a window WD31 in this case may be equivalent to a rotation of a window WD32 in the aligned case, in which case the rotation of the window WD32 may offset the type and number of hatcheries that are excluded from the new window WD31 with those that are added.

Ultimately, in this case, the number of each subpixel within the windows WD31, WD32 remains the same.

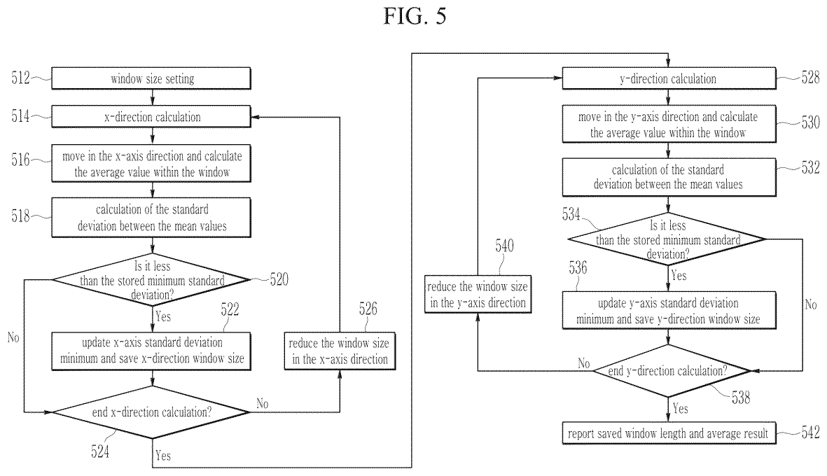

Now, a method for measuring light properties of a display device in an embodiment of the disclosure will be described in detail with reference to FIGS. 5 to 8 together with FIGS. 1 to 3.

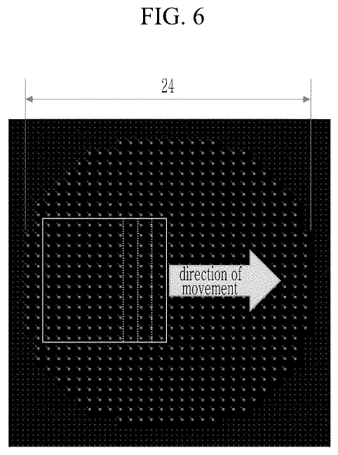

FIG. 5 is a flowchart illustrating an embodiment of a method of measuring light properties of a display device according to the disclosure, and FIGS. 6 to 8 are schematic diagrams illustrating an embodiment of a method of measuring light properties of a display device according to the disclosure.

The method for measuring the light properties of a display device in an embodiment of the disclosure involves determining the light properties (luminance or chromaticity) of a measurement target region 14 based on information measured by photographing a region including the measurement target region 14 with a measuring device 20 from the display device 10. First, a window of an appropriate size that may reduce the error as much as possible is determined, then the average light properties within the window are calculated while moving the window, and these are averaged to determine the final light properties.

The window size determination process is explained in detail.

First, the initial size of the window 26 is set (operation 512). In the target region 24, there may be two or more, typically several to dozens of repeating units of marked pixels, and thus the initial window 26 may be set as a square with each side being about ⅓ to about ½ of the diameter of the target region 24. Assuming that the target region 24 is substantially small and consists of only two repeating units, the initial size of the window 26 may be set to be slightly larger than about ½ the diameter of the target region 24. In an embodiment, when the diameter of the target region 24 is 100 pixels based on the measuring device 20, for example, the initial size of the window 26—that is, the initial side length—may be set to a size slightly larger than 50 pixels (e.g., 55 pixels), for example.

As the initial window 26 determined in this way is moved within the target region 24, the average light characteristic (e.g., average luminance) within the window 26 is calculated at each point. At this time, the movement of the window 26 may be divided into the horizontal direction (x-direction) and the vertical direction (y-direction).

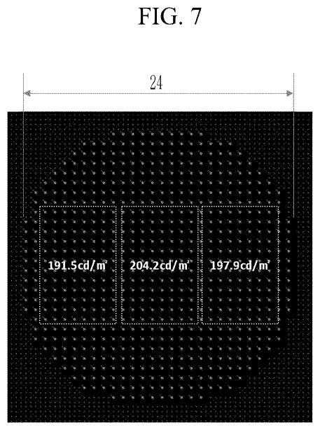

In an embodiment, referring to FIG. 6, an initial window 26 is applied to the left end of the target region 24 and the average luminance within the window 26 is calculated (operation 514), for example. The window 26 may then be moved slightly to the right (e.g., by the size of one pixel of the measuring device 20 pixels). After calculating the average luminance within the moved window 26, the window 26 is moved again in the same manner and the average luminance is calculated. In this way, the average luminance calculation may be repeated (operation 516) until the window 26 reaches the right end of the target region 24, as illustrated in FIG. 7.

The standard deviation of the average luminance within the window 26 calculated in this way is calculated (operation 518) and stored together with the size of the window 26 as the minimum value of the standard deviation. Window size may be expressed in terms of horizontal and vertical length.

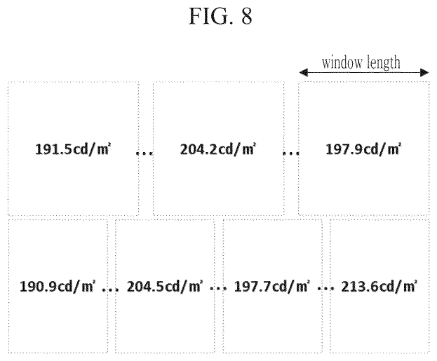

Next, a new window 26 may be set (operation 526) with the horizontal length of the window 26 slightly reduced (e.g., by the size of one pixel of the measuring device 20). The average luminance calculation process described above may be repeated for the newly set window 26, and the standard deviation of the average luminance within the calculated window 26 may be calculated (operation 514 to 518). FIG. 8 schematically illustrates the average luminance within the window 26 at each position for the window 26 having different horizontal lengths. This standard deviation is compared with the minimum value of the previously stored standard deviation (operation 520), and when it is smaller than the minimum value, the minimum value is updated with a new standard deviation and the horizontal length of the window 26 is also updated (operation 522). When the calculated standard deviation is greater than the minimum value, proceed to the next process. In the description, the windows 26 having different sizes from each other may be referred to as temporary windows, and a light characteristic for each position of each of the plurality of temporary windows may be referred to as an in-window light characteristic.

This repetitive calculation may be performed a predetermined number of times. As previously illustrated, when the target region 24 includes two repeating units and the diameter of the target region 24 is about 100 pixels, e.g., repeating calculations may be performed within a range of about 45 pixels to about 55 pixels in the horizontal length of the window. In an embodiment, when the initial horizontal length of the window 26 is set to 55 pixels, for example, the calculation may be repeated by reducing the horizontal length of the window 26 until the horizontal length of the window 26 becomes about 45 pixels. When there is no information about the relationship between the target region 24 and the repeating unit, the calculation may be repeated as many times as 1 minus the initial width of the window.

When the process of reducing the horizontal length of the window 26 and repeating the calculation is completed (operation 524), the horizontal length of the window 26 may be fixed to the stored value, and the vertical length of the window 26 and the calculation of light properties may be conducted in the same manner as in the horizontal direction.

That is, the average luminance within the window 26 at the initial vertical position may be calculated (operation 528), the average luminance within the window 26 at each position is calculated while moving the window 26 in the vertical direction (operation 530), and then the standard deviation of the average luminances within the window 26 may be calculated (operation 532). The standard deviation from the first trial may be stored as a minimum value, and on subsequent trials, the calculated standard deviation may be compared (operation 534) to the minimum value of the stored standard deviation, and when it is less than the minimum value, the minimum value may be updated to the new standard deviation and the vertical length of the window 26 may also be updated (operation 536).

When the repeated process of changing and calculating the vertical length of the window 26 is completed (‘Yes’ in operation 538), the stored size of the window 260—that is, the horizontal and vertical lengths—becomes the appropriate size of the window 26, and the saved window length and the average result are reported (operation 542). When the repeated process of changing and calculating the vertical length of the window 26 is not completed (‘No’ in operation 538), the window size in the vertical direction is reduced (operation 540).

Accordingly, for the determined appropriate window 26, by changing its position within the target region 24 in horizontal and vertical directions, and calculating the average luminance within the window 26 at each position, the final average luminance of the target region 24 may be determined by averaging these average luminance values again.

At this time, the position change of the appropriate window 26 may be performed in accordance with the position changes (operation 516 and operation 530) when calculating the standard deviation described above. In addition, since changing the vertical position of the appropriate window 26 and calculating the average luminance within the window 26 have already been performed when calculating the standard deviation, the value calculated at that time may be saved and used. The position change of the appropriate window 26 may be performed in only one direction (e.g., vertically) and in this case, the value calculated during the standard deviation calculation may be stored and used as-is without additional processing.

In this way, the average luminance calculated by setting and moving an appropriate window 26 for the target region 24 in the measuring device 20 may be determined as the average luminance of the measurement target region 14 of the display device 10.

The average luminance of the measurement target region 14 may be compared with the luminance of the remaining regions 12 within the display device 10, and by correcting the display signal applied to the measurement target region 14 based on the difference, the correction may be made more accurately.

Although the embodiments of the disclosure have been described in detail above, the scope of the disclosure is not limited thereto, and various modifications and improvements made by those skilled in the art using the basic concepts of the disclosure defined in the following claims are also possible.

What is claimed is:

1. A method of measuring light properties of a display device, the method comprising:
measuring the light properties of a measurement target region of the display device using a measuring device with a higher resolution than a resolution of the display device;
determining an appropriate window for a target region of the measuring device corresponding to the measurement target region;
repeatedly changing a position of the appropriate window within the target region;
calculating the average value of light properties within the appropriate window for each position of the appropriate window; and
averaging the average values of the light properties within the appropriate window and determining an average light characteristic value of the measurement target region.

2. The method of measuring light properties of the display device of claim 1, wherein:
the appropriate window is rectangular.

3. The method of measuring light properties of the display device of claim 2, wherein:
the measurement target region of the display device has a structure in which repeating units are repeated,
a size of the appropriate window is a multiple of a size corresponding to the repeating unit in the target region.

4. The method of measuring light properties of the display device of claim 2, wherein:
the determining the appropriate window comprises:
setting a plurality of temporary windows of different sizes for the target region;
repeatedly changing the position of each of the plurality of temporary windows within the target region;
calculating an average value of light properties within a temporary window for each position of each of the plurality of temporary windows;
calculating a standard deviation of the average value of the light properties within the temporary window for each of the plurality of temporary windows;
comparing the standard deviations, and
as a result of the comparing the standard deviations, determining a temporary window with the minimum standard deviation among the plurality of temporary windows as the appropriate window.

5. The method of measuring light properties of the display device of claim 4, wherein:
the setting the plurality of temporary windows of the different sizes comprises:
setting an initial window among the plurality of temporary windows; and
sequentially reducing a size of the initial window to set other temporary windows.

6. The method of measuring light properties of the display device of claim 5, wherein:
the setting the initial window includes setting the size of the initial window to about ⅓ to about ½ of the target region.

7. The method of measuring light properties of the display device of claim 5, wherein:
the setting the initial window includes setting the initial window to a square shape.

8. The method of measuring light properties of the display device of claim 5, wherein:
the setting the other temporary windows comprises:
setting a plurality of first temporary windows by sequentially reducing the size of the initial window in a first direction; and
setting a plurality of second temporary windows by sequentially reducing the size of the initial window in a second direction perpendicular to the first direction.

9. The method of measuring light properties of the display device of claim 2, wherein:
the determining the appropriate window comprises:
setting an initial window for the target region;
setting a plurality of first temporary windows including the initial window by sequentially reducing a size of the initial window in a first direction;
repeatedly changing the position of each of the plurality of first temporary windows within the target region;
calculating an average value of light properties within a first temporary window for each position of each of the plurality of first temporary windows;
calculating a standard deviation of the average value of the light properties within the first temporary window for each of the plurality of first temporary windows;
comparing standard deviations of the plurality of first temporary windows;
as a result of the comparing the standard deviations of the plurality of first temporary windows, determining a first temporary window with the minimum standard deviation among the plurality of first temporary windows as a temporary window;
setting a plurality of second temporary windows including the temporary windows by sequentially reducing sizes of the temporary windows in a second direction perpendicular to the first direction;
repeatedly changing the position of each of the plurality of second temporary windows within the target region;
calculating an average value of light properties within a second temporary window for each position of each of the plurality of second temporary windows;
calculating a standard deviation of the average value of the light properties within the second temporary window for each of the plurality of second temporary windows;
comparing standard deviations of the plurality of second temporary windows; and
as a result of the comparing the standard deviations of the plurality of second temporary windows, determining a second temporary window with the minimum standard deviation among the plurality of second temporary windows as the appropriate window.

10. The method of measuring light properties of the display device of claim 9, wherein:
the setting the initial window includes setting the size of the initial window to about ⅓ to about ½ of the target region.

11. The method of measuring light properties of the display device of claim 9, wherein:
the setting the initial window includes setting the initial window to a square shape.

12. The method of measuring light properties of the display device of claim 1, wherein:
the measurement target region of the display device displays an image together with the remaining region of the display device, and
the measurement target region of the display device has a different pixel arrangement or a different wiring structure than the remaining region.

13. The method of measuring light properties of the display device of claim 1, wherein:
the light properties include at least one of luminance and chromaticity.

14. A method of driving a display device, the method comprising:
determining an average value of light properties of a first region of a display device including a first region and a second region narrower than the first region;
measuring the light properties of the second region using a measuring device with higher resolution than the display device;
determining an appropriate window for a target region of the measuring device corresponding to the second region;
repeatedly changing the position of the appropriate window within the target region;
calculating an average value of light properties within the appropriate window for each position of the appropriate window;
determining an average light characteristic of the second region by averaging the average values of the light properties value within the appropriate window; and
compensating the display signal supplied to the second region based on the difference between the average value of the light properties of the first region and the average value of the light properties of the second region.

15. The method of driving the display device of claim 14, wherein:
the first region and the second region display an image together, and
the second region has a different pixel arrangement or wiring structure than the first region.

16. The method of driving the display device of claim 15, wherein:
the appropriate window is rectangular.

17. The method of driving the display device of claim 16, wherein:
the determining the appropriate window comprises:
setting a plurality of temporary windows of different sizes for the target region;
repeatedly changing the position of each of the plurality of temporary windows within the target region;
calculating an average value of light properties within a temporary window for each position of each of the plurality of temporary windows;
calculating a standard deviation of the average value of light properties within the temporary window for each of the plurality of temporary windows;
comparing the standard deviations; and
as a result of the comparing the standard deviations, determining a temporary window with the minimum standard deviation among the plurality of temporary windows as the appropriate window.

18. The method of driving the display device of claim 16, wherein:
the determining the appropriate window comprises:
setting an initial window for the target region;
setting a plurality of first temporary windows including the initial window by sequentially reducing a size of the initial window in a first direction;
repeatedly changing the position of each of the plurality of first temporary windows within the target region;
calculating an average value of light properties within a first temporary window for each position of each of the plurality of first temporary windows;
calculating a standard deviation of the average value of light properties within the first temporary window for each of the plurality of first temporary windows;
comparing standard deviations of the plurality of first temporary windows;
as a result of the comparing standard deviations of the plurality of first temporary windows, determining a first temporary window with the minimum standard deviation among the plurality of first temporary windows as a temporary window;
setting a plurality of second temporary windows including the temporary windows by sequentially reducing sizes of the temporary windows in a second direction perpendicular to the first direction;
repeatedly changing the position of each of the plurality of second temporary windows within the target region;
calculating an average value of light properties within a second temporary window for each position of each of the plurality of second temporary windows;
calculating a standard deviation of the average value of light properties within the second temporary window for each of the plurality of second temporary windows;
comparing standard deviations of the plurality of second temporary windows; and
comparing standard deviations of the plurality of second temporary windows; and
as a result of the comparing standard deviations of the plurality of second temporary windows, determining a second temporary window with the minimum standard deviation among the plurality of second temporary windows as the appropriate window.

19. The method of driving the display device of claim 18, wherein:
the setting the initial window includes setting the size of the initial window to about ⅓ to about ½ of the target region.

20. The method of driving the display device of claim 18, wherein:
the setting the initial window includes setting the initial window to a square shape.
